(19) United States
(12) Patent Application Publication
(10) Pub. No.: US 2017/0088401 A1
(43) Pub. Date: Mar. 30, 2017

(54) METHOD AND APPARATUS FOR HANDLING LIFT SUBS AND OTHER OBJECTS

(71) Applicant: QUALITY RENTAL TOOLS, INC., Houma, LA (US)

(72) Inventors: FRANCIS PAUL CLEMENTS, HOUMA, LA (US); DAVID ARP, DENVER, CO (US)

(21) Appl. No.: 15/274,636

(22) Filed: Sep. 23, 2016

Related U.S. Application Data
(60) Provisional application No. 62/222,967, filed on Sep. 24, 2015.

(51) Int. Cl. B66C 1/42; E21B 19/06; E21B 19/15

(52) U.S. Cl. CPC B66C 1/42; E21B 19/155; E21B 19/06

(57) ABSTRACT

A lift sub handling assembly for gripping, handling and maneuvering a lift sub or other tubular member. A yoke member defining a slot is rotatably attached to a lifting frame which, in turn, can be suspended from a hoist, winch or other lifting device. A gate can be selectively opened to a lift sub or other tubular member to be received within the slot, and thereafter closed to secure the lift sub or other tubular member in place. A motor can selectively rotate the yoke member relative to the lifting frame, thereby changing orientation of a lift sub or other tubular member held within the slot.

### CROSS REFERENCES TO RELATED APPLICATION

Priority of U.S. Provisional Patent Application Ser. No. 62/222,967, filed Sep. 24, 2015, incorporated herein by reference, is hereby claimed.

### STATEMENTS AS TO THE RIGHTS TO THE INVENTION MADE UNDER FEDERALLY SPONSORED RESEARCH AND DEVELOPMENT

NONE

### BACKGROUND OF INVENTION

1. Field of the Invention

The present invention pertains to a handling assembly that can be used to grip and maneuver tubular members including, without limitation, lift subs and/or other relatively heavy and/or unwieldy objects.

2. Brief Description of the Prior Art

Lift subs, which are well known to those having skill in the art, commonly comprise a tubular body having a first end and a second end; a threaded connection member (typically a male “pin end” threaded connection) is disposed at said first end, while an upset or area of increased outer diameter is disposed at said second end. Such lift subs are frequently used to temporarily screw into one end of a drill collar, other tubular member or downhole equipment which is to be lifted using a rig's hoisting mechanism (such as top drive unit, draw works or the like). Such lift subs provide a temporary connection means that permit attachment to said tubular member or downhole equipment by such hoisting mechanism using latching elevators or gripping means.

Although dimensions and weights can vary, in many cases such lift subs can be relatively large and/or heavy, such that they cannot be easily, safely or conveniently moved simply by personnel or manpower alone. In many cases, said lift subs can be attached to a wire rope or cable and lifted using an air hoist or other ancillary rig lifting device. However, the shape and configuration of said lifting subs frequently render them unwieldy and difficult to control and maneuver when being supported in this manner, especially when being moved into close relationship with a drill collar or other object to be threadably connected.

Thus, there is a need for a device that can quickly and efficiently grip a lift sub and thereafter, conveniently maneuver said lift sub into a desired location. The apparatus should permit alignment of a threaded connection member of said lift sub with a mating threaded connection member of a drill collar or other item, including during connection or disconnection operations.

### SUMMARY OF THE PRESENT INVENTION

In a preferred embodiment, the present invention comprises a handling assembly for use in gripping, lifting and/or maneuvering tubular members and other objects. Although other uses can be envisioned without departing from the scope of the present invention, a beneficial use of the present invention involves gripping, lifting and maneuvering of lift subs used during oil and gas well drilling and/or other operations.

In a preferred embodiment, the lift sub handling assembly of the present invention comprises a lift support frame, beneficially constructed of tubular or structural members. Said support frame further comprises a top member and a plurality of side members extending from said top member; said sides members are oriented in a substantially parallel configuration relative to each other and cooperate to form an inner gap.

The lift sub handling assembly of the present invention further comprises a yoke member having a concave “cuff-like” shape and defining a slot or opening having a substantially semi-circular configuration. A shaft extends outwardly from each side of said yoke member and is rotatably attached to the side members of said support frame. Bearings can be installed between each of said shafts and said sides of said support frame to beneficially reduce rotational friction of said yoke member.

A first substantially planar weldment member is attached to a front surface of said curved housing member, while a second substantially planar weldment member is affixed to a rear surface of said curved housing member. A plurality of roller sets are disposed through a plurality of apertures extending through each of said weldment members. A gate sleeve is slideably disposed along a curved upper surface of said yoke member, and secured against said upper surface by said roller sets.

The lift sub handling assembly of the present invention further comprises an air motor and gearbox. Said air motor and gearbox are attachably connected to said lift frame member and yoke member. Further, the present invention comprises a valve plate that is attachably connected to the support ring of the present invention.

The present invention comprises a handling assembly for use in gripping, lifting and/or maneuvering tubular members. Although other uses can be envisioned without departing from the scope of the present invention, the handing assembly of the present invention permits gripping, lifting and maneuvering of lift subs that cannot be easily, safely or conveniently moved by personnel or manpower alone.

More particularly, the present invention permits secure gripping of a lift sub, as well as support of said lift sub while being suspended from a hoist or other lifting device. When held by the assembly of the present invention, a lift sub can be conveniently tilted or aligned for efficient and convenient threaded connection to another tubular member or object. The assembly of the present invention permits maximum control and maneuverability of a lift sub when being supported in this manner, especially when being moved into close relationship with a drill collar or other object to which connection to said lift sub is desired.

### BRIEF DESCRIPTION OF DRAWINGS

The foregoing summary, as well as any detailed description of the preferred embodiment, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts an overhead perspective view of a lift sub handling assembly of the present invention in an open configuration.

FIG. 2 depicts an overhead perspective view of a lift sub handling assembly of the present invention in a closed configuration.

FIG. 3 depicts a side view of a lift sub handling assembly of the present invention.

FIG. 4 depicts a front view of a lift sub handling assembly of the present invention.

FIG. 5 depicts a front sectional view of a lift sub handling assembly of the present invention.

FIG. 6 depicts an overhead perspective view of a lift sub handling assembly of the present invention during the process of gripping a lift sub.

FIG. 7 depicts an overhead perspective view of a lift sub handling assembly of the present invention gripping a lift sub.

FIG. 8 depicts an overhead perspective view of a lift sub handling assembly of the present invention gripping a lift sub, wherein said lift sub is oriented approximately ninety degrees from the orientation depicted in FIG. 7.

### DETAILED DESCRIPTION OF A PREFERRED EMBODIMENT

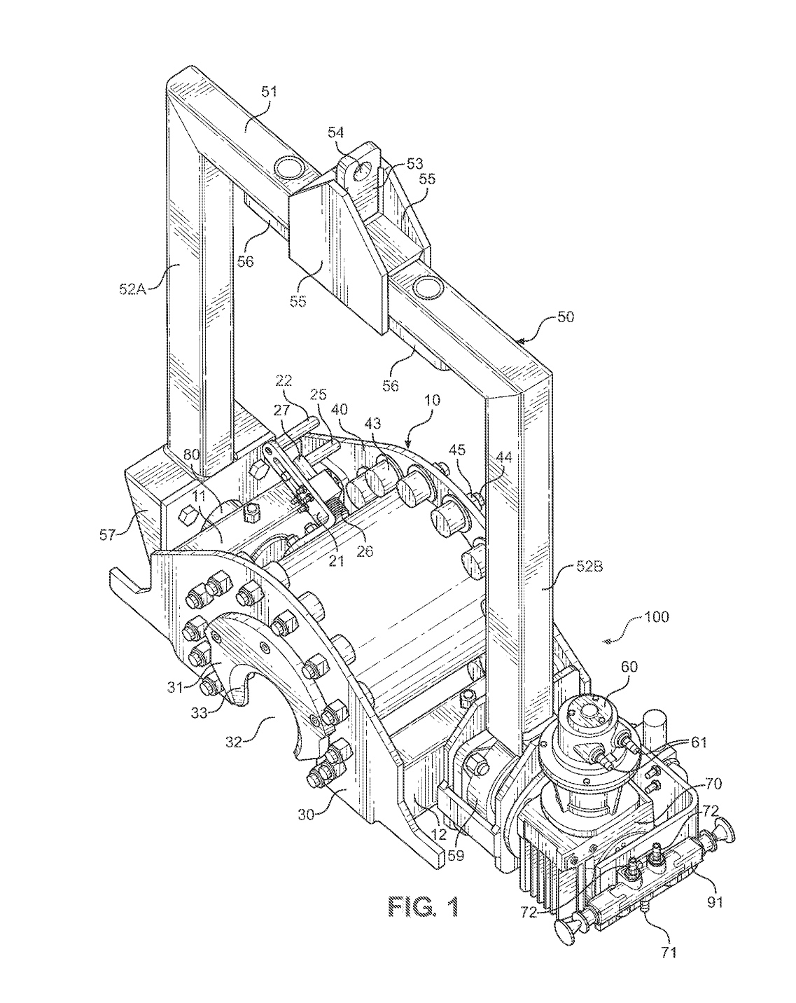

FIG. 1 depicts an overhead perspective view of a lift sub handling assembly 100 of the present invention in an open configuration. In a preferred embodiment, lift sub handling assembly 100 of the present invention comprises an apparatus for use in gripping, lifting and/or maneuvering tubular members and other objects. Although other uses can be envisioned without departing from the scope of the present invention, a beneficial use of the present invention involves gripping, lifting and maneuvering of lift subs used during oil and gas well drilling and/or other operations.

In a preferred embodiment, lift sub handling assembly 100 of the present invention comprises a lift support frame 50, which can be beneficially constructed of tubular or structural members. Said support frame 50 further comprises an upper member 51 and a plurality of side members 52a and 52b extending from said top member 51; said side members 52a and 52b are oriented in a substantially parallel configuration relative to each other and cooperate to define an inner gap formed between said side members 52a and 52b.

Lifting pad-eye 53 having aperture or eyelet 54 is disposed on the upper surface of upper member 51, beneficially at or near the longitudinal midpoint of said upper member 51. Aperture 54 can provide an attachment point for operational attachment of lift sub handling assembly 100 to a hoist, winch or other lifting device. Optional structural support plates 55 can be attached to said pad-eye 53 and upper member 51 to provide strength to said pad-eye 53, especially when said lift sub handling assembly 100 is being lifted or otherwise suspended using a hoist, winch or other lifting device. Additionally, optional reinforcement members 56 can be attached to upper member 51 to provide additional strength to said upper member 51.

Lift sub handling assembly 100 of the present invention further comprises a central yoke member 10. In a preferred embodiment, said central yoke member 10 generally comprises mounting blocks 11 and 12. Said mounting blocks 11 and 12 are oriented substantially parallel to each other, and cooperate to provide a mounting surface for operational attachment of first weldment plate 30 and second weldment plate 40.

Still referring to FIG. 1, first plate 30 and second plate 40 are substantially planar members that are oriented substantially parallel to each other (and substantially perpendicular to the longitudinal axes of mounting blocks 11 and 12). Reinforcing collar plate 31 is attached to first plate 30 and defines a substantially semi-circular slot 32 having a beveled or tapered surface 33 extending around said opening. Although not visible in FIG. 1, an identical or substantially similar reinforcing collar plate 41 is installed on second plate 40, and also defines a substantially semi-circular opening that is aligned with slot 32.

Housing 57 is attached to side member 52a. Rigid shaft 80 extends outwardly from the outer surface of mounting block 11 and is rotatably received within aperture 58 formed in housing 57; optional bearings (not visible in FIG. 1) can be installed within housing 57 to reduce rotational friction of rigid shaft 80. Housing 59 is attached to side member 52b, and is generally aligned with housing member 57. Although not visible in FIG. 1, a rigid drive shaft 90 extends outwardly from the outer surface of mounting block 12 and is rotatably received within an aperture formed in housing 59.

Gear assembly 70 is mounted to housing member 59, while motor 60 is operationally mounted to said gear assembly 70. As depicted in FIG. 1, motor 60 is air-powered; however, it is to be observed that motor 60 can be powered using another fluid (such as, for example, hydraulic fluid), electricity or other power source without departing from the scope of the present invention. In the embodiment depicted in FIG. 1, air inlet port 71 of air manifold 91 can be attached with an air supply hose (such as, for example, from a drilling rig air system). Conventional hoses or lines (not shown) can then attach to manifold outlet ports 72 and extend to air inlet ports 61 to power motor 60.

Motor 60 is used to selectively drive gear assembly 70 as described more fully below. In a preferred embodiment, said gear assembly 70 comprises a worm gear assembly; however, another type of gear assembly can be utilized without departing from the scope of the present invention.

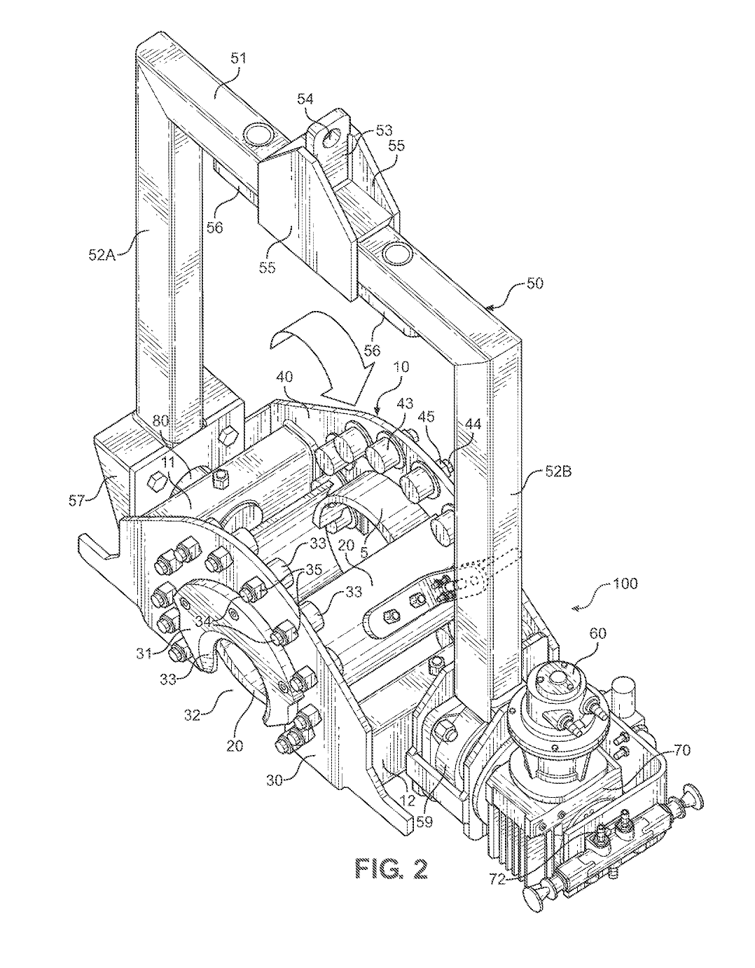

FIG. 2 depicts an overhead perspective view of lift sub handling assembly 100 of the present invention in a closed configuration. A curved or concave sleeve-like body member 5 at least partially extends between first plate 30 and second plate 40. A curved or concave gate sleeve member 20, having a larger radius of curvature than body member 5, is slidably disposed over the outer surface of said body member 5. Referring back to FIG. 1, mounting bracket 21 having handle 22 is operationally attached to gate member 20. In a preferred embodiment, locking post 27 having locking handle 25 and bias spring 26 is attached to mounting bracket 21 and can be used to selectively lock gate sleeve member 20 in a desired position.

Referring to FIG. 2, a plurality of rollers 33 is bolted through a plurality of apertures extending through plate member 30 using threaded bolts 34 and nuts 35. Similarly, a plurality of rollers 43 are likewise bolted through a plurality of apertures extending through plate member 40 using threaded bolts 44 and nuts 45. Said rollers 33 and 43 generally conform to the radius of curvature of gate member 20, securing said gate member 20 in place against the outer peripheral surface of underlying body member 5, while permitting said gate member 20 to slide over said outer peripheral surface of body member 5 in the direction of the arrow depicted in FIG. 2. Said rollers 33 and 43 reduce friction as said gate member 20 slides in such manner.

When gate member 20 is closed as depicted in FIG. 2, said gate member 20 effectively closes or blocks the throat or opening to slot 32. As described in more detail herein, gate member 20 can be positioned in an open configuration as depicted in FIG. 1, thereby permitting a lift sub or other tubular member to be received within said slot 32 (as well as aligned slot 42 in plate member 40, not visible in FIG. 2). After said lift sub or other tubular member has been inserted into said slot 32 (and aligned slot 42, not visible in FIG. 2), gate member 20 can be closed by sliding said gate member 20 in the direction of said arrow, thereby securing said lift sub or other tubular member in place within said slots.

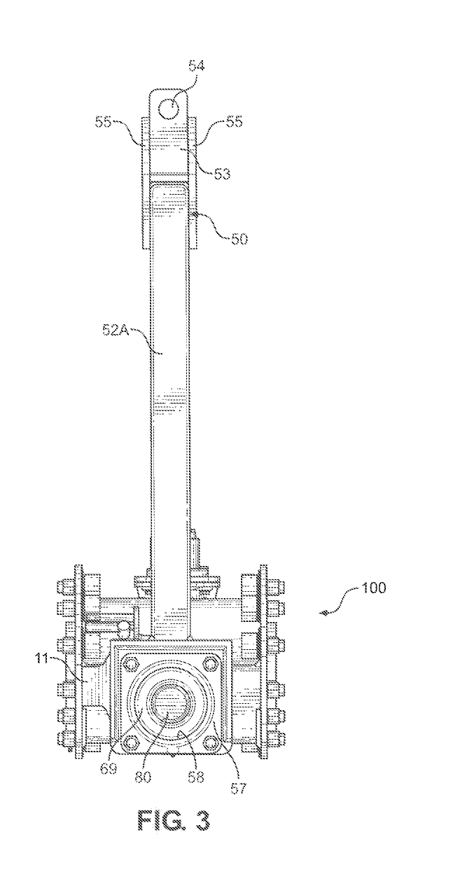

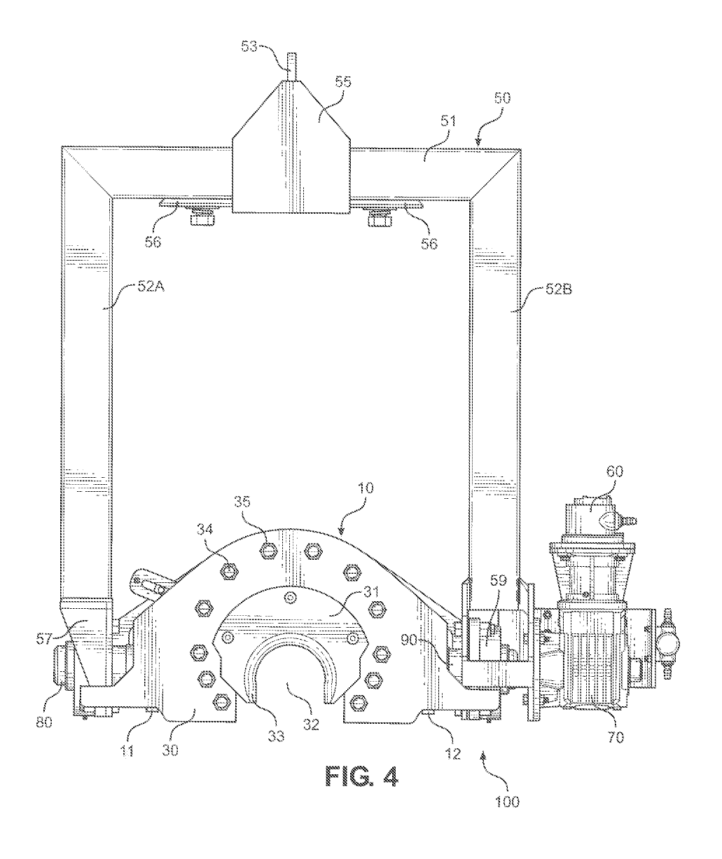

FIG. 3 depicts a side view of lift sub handling assembly 100 of the present invention, while FIG. 4 depicts a front view of lift sub handling assembly 100 of the present invention. Referring to FIG. 3, housing 57 is attached to side member 52a. Rigid shaft 80 extends outwardly from the outer surface of mounting block 11 and is rotatably received within aperture 58 formed in housing 57. Optional bearings 69 can be installed within housing 57 to reduce rotational friction of rigid shaft 80.

Referring to FIG. 4, lift sub handling assembly 100 of the present invention further comprises a central yoke member 10. In a preferred embodiment, said central yoke member 10 generally comprises mounting blocks 11 and 12. First plate 30 is oriented substantially perpendicular to the longitudinal axes of mounting blocks 11 and 12. Reinforcing collar plate 31 is attached to first plate 30 and defines a substantially semi-circular slot 32 having a beveled or tapered surface 33 extending around said opening.

Housing 57 is attached to side member 52a. Rigid shaft 80 extends outwardly from the outer surface of mounting block 11 and is rotatably received within aperture 58 formed in housing 57. Housing 59 is attached to side member 52b, and is generally aligned with housing member 57. Rigid drive shaft 90 extends outwardly from the outer surface of mounting block 12 and is rotatably received within an aperture formed in housing 59. Gear assembly 70 is mounted to housing member 59, while motor 60 is operationally mounted to said gear assembly 70.

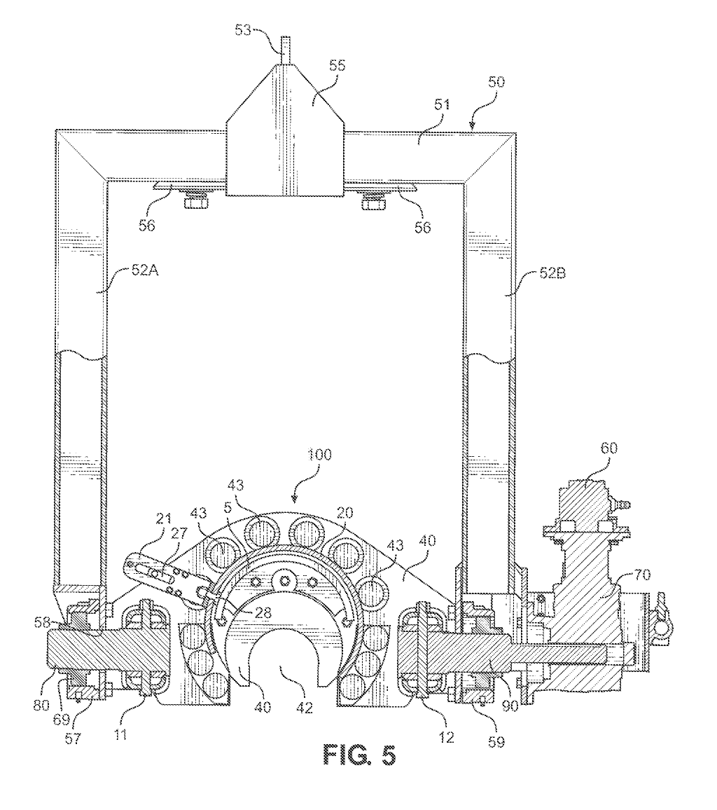

FIG. 5 depicts a front sectional view of lift sub handling assembly 100 of the present invention. Lift sub handling assembly 100 of the present invention comprises a lift support frame 50, which can be beneficially constructed of tubular or structural members. Said support frame 50 further comprises an upper member 51 and a plurality of side members 52a and 52b extending from said top member 51; said side members 52a and 52b are oriented in a substantially parallel configuration relative to each other and cooperate to define an inner gap formed between said side members 52a and 52b.

Lifting pad-eye 53 (having aperture or eyelet 54 not visible in FIG. 5) is disposed on the upper surface of upper member 51, beneficially at or near the longitudinal midpoint of said upper member 51. Optional structural support plates 55 can be attached to said pad-eye 55 to provide strength to said pad-eye 55, while optional reinforcement members 56 can be attached to upper member 51 to provide additional strength to said upper member 51.

Lift sub handling assembly 100 of the present invention further comprises mounting blocks 11 and 12. Said mounting blocks 11 and 12 are oriented substantially parallel to each other. Second plate 40 comprises a substantially planar member that is oriented substantially perpendicular to the longitudinal axes of mounting blocks 11 and 12. Reinforcing collar plate 41 is installed on second plate 40, and also defines a substantially semi-circular slot 42. Reinforcing collar plate 41 and reinforcing collar plate 31 (not visible in FIG. 5, but visible in FIGS. 1 and 2) can be removed and efficiently replaced with interchangeable collar plates having aligned slots 42 and 32, respectively, having different desired dimensions.

Housing 57 is attached to side member 52a. Rigid shaft 80 extends outwardly from the outer surface of mounting block 11 and is rotatably received within aperture 58 formed in housing 57; optional bearings 69 can be installed within housing 57 to reduce rotational friction of rigid shaft 80. Housing 59 is attached to side member 52b, and is generally aligned with housing member 57. Rigid drive shaft 90 extends outwardly from the outer surface of mounting block 12 and is rotatably received within an aperture formed in housing 59. Gear assembly 70 is mounted to housing member 59, while motor 60 is operationally mounted to said gear assembly 70. Motor 60 is used to selectively drive gear assembly 70 in order to rotate drive shaft 90 about its longitudinal axis.

Curved or concave sleeve-like body member 5 extends from second plate member 40. Curved or concave gate member 20, having a larger radius of curvature than body member 5, is slidably disposed over the outer surface of said body member 5. Mounting bracket 21 (having handle 22, not visible in FIG. 1) is operationally attached to gate member 20.

A plurality of rollers 43 are bolted through a plurality of apertures extending through plate member 40. Said rollers 43 generally conform to the radius of curvature of gate member 20, securing said gate member in place against underlying body member 5, while permitting said gate member 20 to slide over the outer peripheral surface of body 5. Referring to FIGS. 1 and 5, locking handle 25 can be squeezed against handle member 22, causing bias spring 26 to compress. When this occurs, sleeve stop 28 is lifted away from the outer surface of body member 5, permitting gate member 20 to rotate freely around the outer surface of body member 5. When gate member 20 is moved to a desired position, said locking handle 25 is released, permitting bias spring 26 to force sleeve stop 28 against the outer surface of body member 5, thereby frictionally locking said gate member 20 in place relative to body 5.

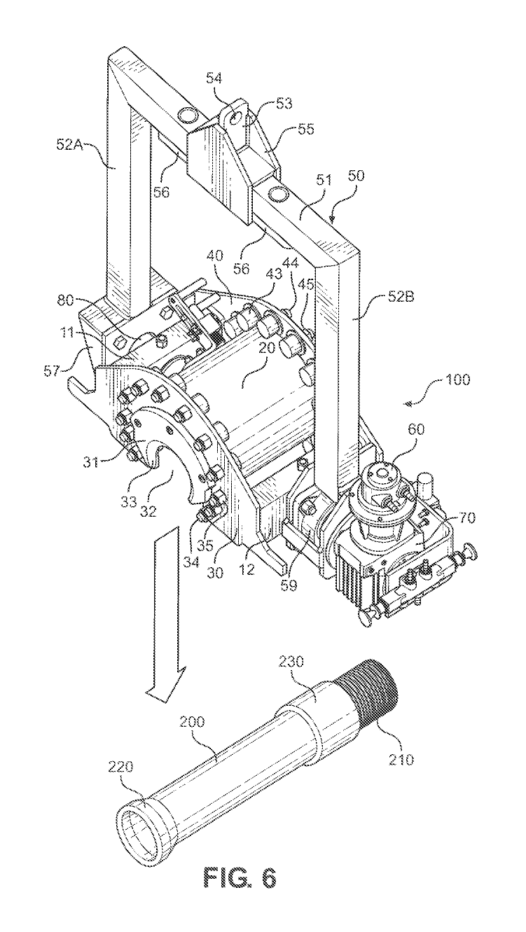

FIG. 6 depicts an overhead perspective view of lift sub handling assembly 100 of the present invention during the process of gripping a lift sub 200. Gate member 20 is positioned in an open configuration, thereby permitting a lift sub or other tubular member 200 to be received within aligned slots 32 (and 42, not visible in FIG. 6).

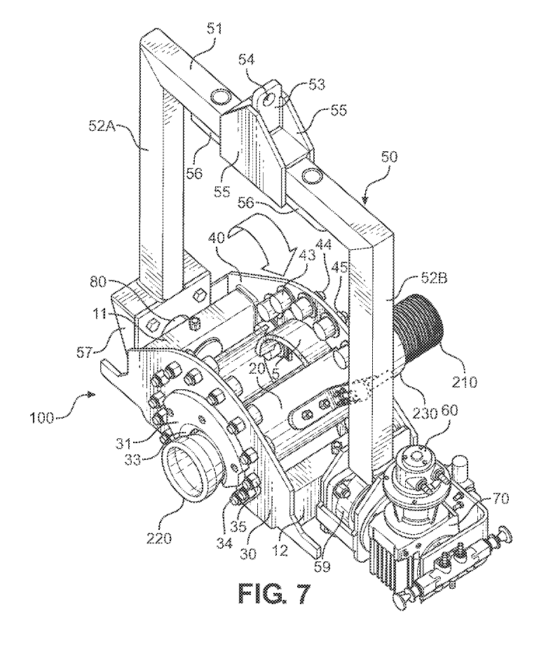

FIG. 7 depicts an overhead perspective view of said lift sub handling assembly 100 of the present invention gripping lift sub 200. After said lift sub 200 has been inserted into said aligned slots 32 (and 42, not visible in FIG. 7), gate member 20 can be closed, thereby holding said lift sub or other tubular member 200 in place within said aligned slots; upper upset area 220 and lower connection upset area 230 have a larger diameter than aligned slots 32 and 42, and cannot pass through said slots. Said gate member 20 can be secured or locked in place in said closed position to ensure that lift sub 200 does not fall out of said aligned slots. In this configuration, lift sub handling assembly 100 permits secure holding of lift sub 200.

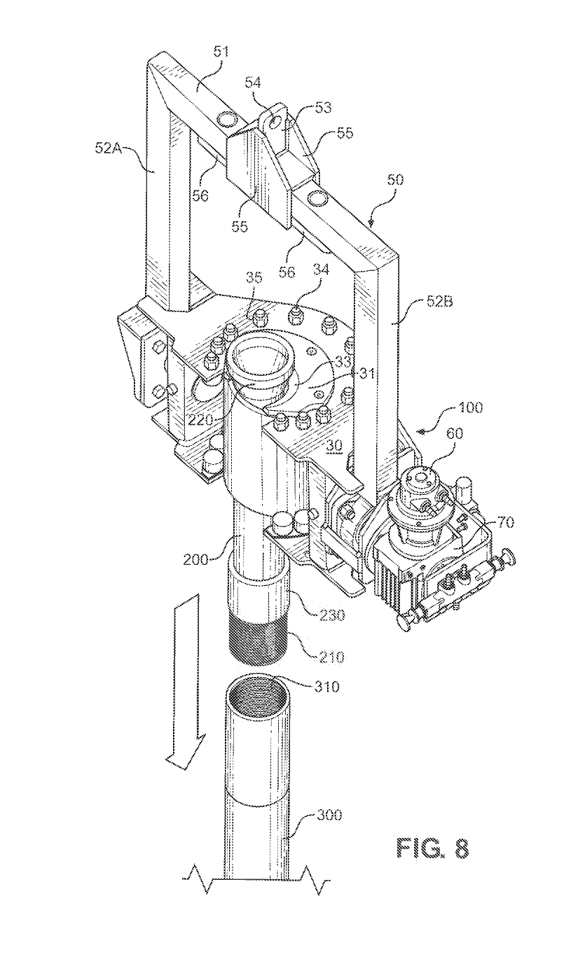

FIG. 8 depicts an overhead perspective view of lift sub handling assembly 100 of the present invention gripping lift sub 200, wherein said lift sub is oriented approximately ninety degrees from the orientation depicted in FIG. 7. In this configuration, lift sub 200 is axially aligned with tubular member 300. More specifically, male pin-end threaded connection 210 of lift sub 200 is aligned with female box-end threaded connection 310 of a tubular member 300 (which can be a drill collar or other tubular), thereby allowing movement of lift sub 200 toward tubular member 300 (or vice versa). Further, lift sub handling assembly 100 permits rotation of one or both lift sub 200 or tubular member 300, and threaded connection of mating threaded members 210 and 310.

Although FIGS. 6-8 depict lift sub handling assembly 100 used during connection of lift sub 200 to a tubular member 300, it is to be observed that said lift sub handling assembly 100 can likewise be used for disconnection of said objects. In such cases, gate member 20 is positioned in an open configuration. Lift sub handling assembly 100 is maneuvered to a desired position (typically using a hoist, winch or other lifting device attached to lifting frame 50), so that a lift sub or other tubular member can be received within aligned slots 32 and 42.

After said lift sub is inserted into said aligned slots 32 and 42, gate member 20 can be closed and locked in place, thereby holding said lift sub or other tubular member in place within said aligned slots. Said gate member 20 can be secured or locked in place in said closed position to ensure that lift sub does not fall out of said aligned slots. In this configuration, lift sub handling assembly 100 permits secure holding of said lift sub, as well rotation of one or both said lift sub or tubular member, and disconnection of mating threaded connection members thereof. Once disconnected, said lift sub can be safely and conveniently moved away from said tubular member and stored or reused.

The present invention comprises a handling assembly for use in gripping, lifting and/or maneuvering tubular members. Although other uses can be envisioned without departing from the scope of the present invention, the handing assembly of the present invention permits gripping, lifting and maneuvering of lift subs that cannot be easily, safely or conveniently moved by personnel or manpower alone.

More particularly, the present invention permits secure gripping of a lift sub, as well as support of said lift sub while being suspended from a hoist or other lifting device. When held by the assembly of the present invention, a lift sub can be conveniently tilted or aligned for efficient and convenient threaded connection to another tubular member or object, such as a drill collar. The assembly of the present invention permits maximum control and maneuverability of a lift sub when being supported in this manner, especially when being moved into close relationship with a drill collar or other object to which connection to said lift sub is desired.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. An apparatus for handing lift subs and other tubular members comprising:
a) a tubular frame defining an opening;
b) a yoke member defining a slot, wherein said yoke member is rotatably disposed within said opening; and
c) a gate member adapted to selectively block access to said slot.

2. The apparatus of claim 1, further comprising a motor adapted to rotate said yoke member.

3. The apparatus of claim 2, further comprising a gear assembly.
